(19) United States
(12) Patent Application Publication
(10) Pub. No.: US 2026/0057266 A1
(43) Pub. Date: Feb. 26, 2026

(54) DATA ESTIMATION DEVICE, DATA ESTIMATION METHOD, AND RECORDING MEDIUM

(71) Applicant: NEC Corporation, Tokyo (JP)

(72) Inventors: Keisuke SUZUKI, Tokyo (JP); Yuki KOSAKA, Tokyo (JP); Kosuke NISHIHARA, Tokyo (JP); Kentaro NAKAHARA, Tokyo (JP); Fumiyuki NIHEY, Tokyo (JP); Mana HASHIMOTO, Tokyo (JP)

(73) Assignee: NEC Corporation, Tokyo (JP)

(21) Appl. No.: 19/291,676

(22) Filed: Aug. 6, 2025

(30) Foreign Application Priority Data
Aug. 26, 2024 (JP) 2024-144017

(51) Int. Cl. G06N 7/01

(52) U.S. Cl. CPC G06N 7/01

(57) ABSTRACT

A data estimation device includes an acquisition unit, a stratification unit, an estimation unit, and an output unit. The acquisition unit acquires data sets including pieces of data indicating mutually different probability distributions and an attribute used for stratification of the data sets. The stratification unit stratifies the data sets based on the attribute. The estimation unit estimates a state transition probability between the data sets after the stratification based on a difference in distribution between a state transition probability between the data sets before the stratification and a state transition probability between the data sets stratified for each of the attributes. The output unit outputs the state transition probability between the data sets after the stratification. The use of the state transition probability estimated in this manner enables the data estimation device to support decision making based on an estimation result of a transition destination of data.

This application is based upon and claims the benefit of priority from Japanese Patent Application No. 2024-144017, filed on Aug. 26, 2024 the disclosure of which is incorporated herein in its entirety by reference.

### TECHNICAL FIELD

The present disclosure relates to a data estimation device and the like.

### BACKGROUND ART

In data analysis or the like, a transition of data may be estimated based on a state transition probability between a plurality of data sets having mutually different distributions. A prediction model construction device of JP 2016-95684 A clusters pieces of medical data in the form of a word frequency for each age to generate a cluster for each age. Then, the prediction model construction device of JP 2016-95684 A estimates a transition probability in an aging direction between clusters in adjacent ages based on a similarity between the clusters.

### SUMMARY

An object of the present disclosure is to provide a data estimation device and the like capable of suppressing over-learning in estimation of a state transition probability between stratified data sets.

A data estimation device according to an aspect of the present disclosure includes an acquisition unit that acquires data sets including pieces of data indicating mutually different probability distributions and an attribute used for stratification of each of the data sets, a stratification unit that stratifies each of the data sets based on the acquired attribute, an estimation unit that estimates a state transition probability between data sets after the stratification based on a difference in distribution between a state transition probability between the data sets before the stratification and a state transition probability between data sets stratified for each of the attributes, and an output unit that outputs the state transition probability between the data sets after the stratification.

A data estimation method according to an aspect of the present disclosure includes acquiring data sets including pieces of data indicating mutually different probability distributions and an attribute used for stratification of each of the data sets, stratifying each of the data sets based on the acquired attribute, estimating a state transition probability between data sets after the stratification based on a difference in distribution between a state transition probability between the data sets before the stratification and a state transition probability between data sets stratified for each of the attributes, and outputting the state transition probability between the data sets after the stratification.

A non-transitory recording medium according to an aspect of the present disclosure recording a data estimation program causes a computer to execute processing including acquiring data sets including pieces of data indicating mutually different probability distributions and an attribute used for stratification of each of the data sets, stratifying each of the data sets based on the acquired attribute, estimating a state transition probability between data sets after the stratification based on a difference in distribution between a state transition probability between the data sets before the stratification and a state transition probability between data sets stratified for each of the attributes, and outputting the state transition probability between the data sets after the stratification.

### BRIEF DESCRIPTION OF THE DRAWINGS

Exemplary features and advantages of the present invention will become apparent from the following detailed description when taken with the accompanying drawings in which:

FIG. 1 is a diagram illustrating an example of a configuration of a data estimation system according to the present disclosure;

FIG. 2 is a view illustrating an example of data transition according to the present disclosure;

FIG. 3 is a diagram illustrating an example of a configuration of a data estimation device according to the present disclosure;

FIG. 4 is a view illustrating an example of an operation flow of the data estimation device according to the present disclosure;

FIG. 5 is a view illustrating an example of an operation flow of the data estimation device according to the present disclosure; and

FIG. 6 is a diagram illustrating an example of a hardware configuration of the data estimation device according to the present disclosure.

### EXAMPLE EMBODIMENT

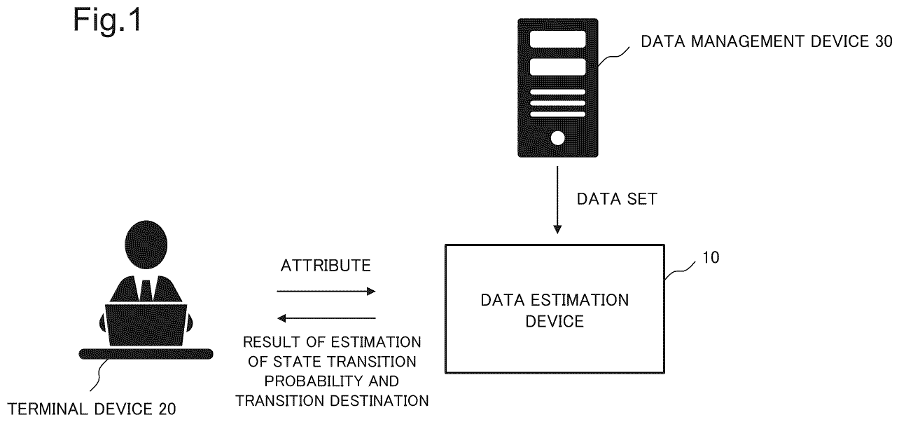

Example embodiments of the present disclosure will be described in detail with reference to the drawings. FIG. 1 is a diagram illustrating an example of a configuration of a data estimation system. The data estimation system includes a data estimation device 10, a terminal device 20, and a data management device 30. The data estimation device 10 is connected to the terminal device 20 via, for example, a network. The data estimation device 10 is connected to the data management device 30 via, for example, a network. A plurality of terminal devices 20 and a plurality of data management devices 30 may be provided. The number of terminal devices 20 and the number of data management devices 30 can be appropriately set.

The data estimation system estimates, for example, a state transition probability between data sets stratified based on an attribute. The data estimation system stratifies, for example, two data sets indicating probability distributions different from each other based on the attribute. Then, the data estimation system estimates, for example, a state transition probability between the two data sets stratified based on the attribute using an algorithm related to optimal transport. The algorithm related to optimal transport is an algorithm for solving a target problem as an optimal transport problem. For example, the data estimation system estimates a transition destination on a probability distribution of one data set of the two stratified data sets for data on the probability distribution of the other data set based on the estimated state transition probability.

The attribute is, for example, information indicating a feature of an owner of data. The owner of the data is, for example, information indicating what the data is related to. For example, in a case where data is a person, an owner of the data is the person. For example, when data is an object, an owner of the data is the object. In a case where data is data related to a person, the attribute is, for example, information indicating a feature of the person. In this case, the attribute is one or more pieces of information among nationality, race, occupation, job history, educational background, family structure, domicile, height, weight, hobby, medical care history, and friendship of the person that is a target of data. In a case where data is data related to an object, an attribute is, for example, information indicating a feature of the object. The attribute is not limited to the above.

Each of the data sets is configured, for example, by classifying pieces of cross-sectional data. Pieces of the cross-sectional data are, for example, pieces of data collected at a time point, and pieces of data having different positions in a time-series direction with respect to an owner of the data. The time point may have a period of time. The time point may have a period of time, for example, within the same year. For example, in a case where the data is data associated to a person, a position in the time-series direction with respect to an owner of the data is the age of the person related to the data. For example, in a case where the data is data related to an object, a position in the time-series direction with respect to an owner of the data is an elapsed period, and the elapsed period is, for example, a period of time from the start of use, manufacture, or installation of the object to which the data is associated. The position in the time-series direction is not limited to the above. For example, in a case where the data set includes pieces of data related to a medical examination result, each of the data sets includes, for example, results of medical examinations for each age group performed within the same year. In this case, the medical examination result is an example of health-related data.

The data estimation system estimates, for example, a state transition probability between data sets obtained by classifying pieces of cross-sectional data in the time-series direction. In a case where the data set includes pieces of data related to a person, the data sets include, for example, pieces of data related to persons of mutually different age groups. For example, when there are two data sets and a first data set includes pieces of data related to persons in the age of 50s, a second data set is a data set related to persons in the age of 70s. In this case, the data estimation system estimates a state transition probability from data included in the data set in the age of 50s to data included in the data set in the age of 70s. Then, the data estimation system estimates data in a case where a target person, who is a person being a target of estimation of a time-series change, is in the age of 70s based on data of the target person in the age of 50s and the state transition probability. Since a transition destination of data is estimated based on the state transition probability estimated based on the cross-sectional data in this manner, it is possible to estimate the time-series change of the target person without requiring time-series data for the same person as learning data.

In a case where the data set includes pieces of data related to an object, the data sets include pieces of data related to objects having mutually different elapsed years. For example, when there are two data sets and the data sets are data sets related to a machines, the data sets include pieces of data related to the machines having mutually different elapsed years from installation. For example, when a first data set includes pieces of data related to machines less than five years old from installation, a second data set is a data set related to machines five years old or more from installation. In this case, the data estimation system estimates a state transition probability from data included in the data set related to the machines less than five years old from installation to data included in the data set related to machines five years old or more from installation. Then, the data estimation system estimates data in a case where the elapsed years are five years or more based on the state transition probability and data of a machine that has been installed less than five years, the machine being a target of estimation of a time-series change.

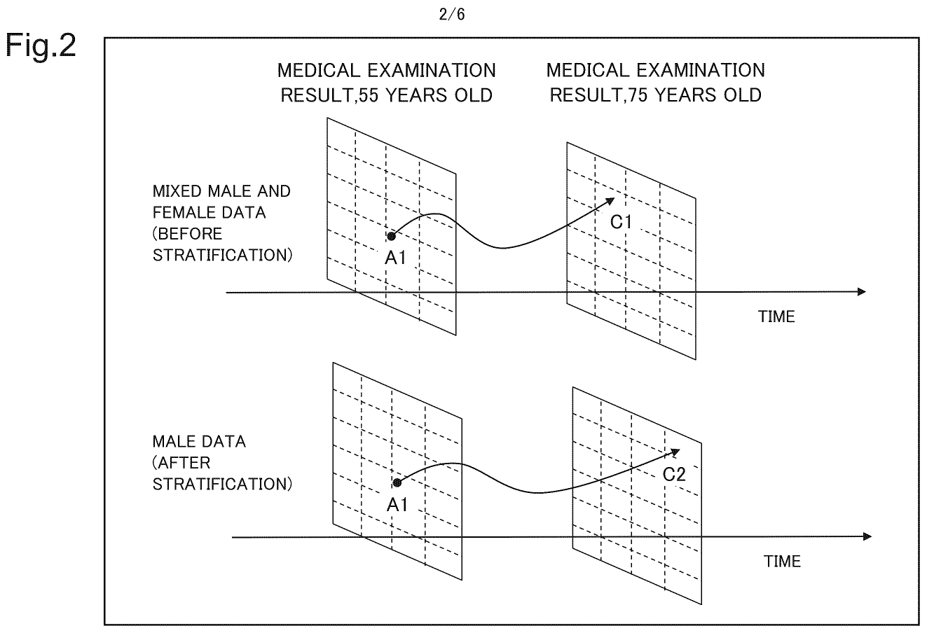

In a case where the data set includes pieces of health-related data, the data estimation system estimates, for example, a state transition probability between pieces of health-related data for each of age groups stratified based on an attribute. FIG. 2 is a view schematically illustrating an example of a transition of data in a case where a medical examination result is used as a data set. The example of FIG. 2 illustrates a transition of data from a probability distribution in results of the medical examination for the age of 55 to a probability distribution in results of the medical examination for the age of 75. The example of FIG. 2 illustrates a transition of data in a case where stratification has not been performed based on an attribute and a transition of data in a case where stratification has been performed based on gender as the attribute. In the example of FIG. 2, in the case where stratification has not been performed, a medical examination result on a person belonging to a data group A1 at the age of 55 transitions to a data group C1 when the age of the person increases to 75. On the other hand, in the example of FIG. 2, in the case where stratification has been performed, the medical examination result on the person belonging to the data group A1 at the age of 55 transitions to a data group C2 when the age of the person increases to the age of 75.

When stratification is performed in this manner, a transition destination of data may change. Therefore, the accuracy of estimation of a transition destination of data can be improved by estimating the transition destination of the data in data sets stratified based on an attribute. On the other hand, since the quantity of data is reduced if stratification is performed, an over-learning state that is strongly affected by some data is caused, and the accuracy of estimation of a transition destination of data may be deteriorated. For example, in order to suppress such an over-learning state, the data estimation device 10 estimates a state transition probability between stratified data sets by regularizing the state transition probability so as not to deviate from a tendency of a state transition probability between unstratified data sets.

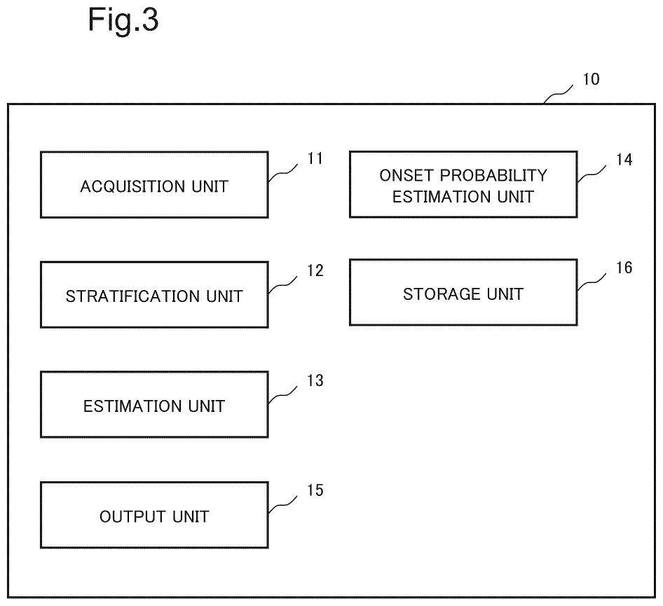

Here, an example of a configuration of the data estimation device 10 will be described. FIG. 3 is a diagram illustrating the example of the configuration of the data estimation device 10. The data estimation device 10 includes an acquisition unit 11, a stratification unit 12, an estimation unit 13, and an output unit 15 as a basic configuration. The data estimation device 10 further includes, for example, an onset probability estimation unit 14 and a storage unit 16.

The acquisition unit 11 acquires data sets including pieces of data indicating mutually different probability distributions and an attribute used for stratification of the data sets. For example, the acquisition unit 11 acquires, for example, two data sets including pieces of data indicating probability distributions different from each other and an attribute used for the stratification of the data sets.

For example, the acquisition unit 11 acquires a data set including pieces of data having different positions in the time-series direction. The data set including pieces of data having different positions in the time-series direction is, for example, a data set obtained by classifying pieces of cross-sectional data in the time-series direction. For example, data sets having different positions in the time-series direction are data sets obtained by setting different age groups or elapsed years for the data sets, restively.

The data set including pieces of data indicating mutually different probability distributions is, for example, a data set obtained by classifying pieces of cross-sectional data in the time-series direction. The data sets including data indicating mutually different probability distributions are, for example, data sets having mutually different probability distributions when the probability distributions of the respective data sets are generated.

The acquisition unit 11 acquires, for example, data sets each including pieces of health-related data. In a case where a data set includes pieces of health-related data, the data sets include, for example, pieces of health-related data in a first age group and a second age group that is an age group older than the first age group. For example, in a case where the data set includes pieces of health-related data, each of the data sets includes pieces of health-related data in a population of each age group. For example, since pieces of health-related data show different tendencies depending on the age groups, pieces of the health-related data associated to the respective age groups may have different probability distributions. The acquisition unit 11 acquires, for example, data sets to be used for estimating a state transition probability from the data management device 30.

The health-related data is, for example, data indicating a health condition. The health-related data is, for example, data of one or more items among a medical examination result, a test value in a hospital, vital data, presence or absence of onset of a disease, a probability of onset of a disease, opinions of a physician, an exercise function, necessity of care, and a degree of necessary care. The medical examination result is, for example, data of one or more items among a height, a weight, a visual acuity, a blood pressure, an abdominal circumference, a hearing acuity, a measured value in a blood test, an image diagnosis result, and a physician interview result measured in a medical examination. The health-related data may also include costs required for maintaining a health condition or daily living. The health-related data is not limited to the above.

In a case where the health-related data is the medical examination result, the acquisition unit 11 acquires, for example, the medical examination result within a predetermined period as the health-related data. The predetermined period is, for example, a period in which a sufficient number of pieces of data can be collected, and is set as a period in which a tendency of data does not change. The fact that the tendency of data does not change means that, for example, data can be acquired with the same standard without changing the standard of implementation of the medical examination. The predetermined period is, for example, within the same year. The predetermined period may be a plurality of years. The predetermined period may be one month or multiple months. The predetermined period is not limited to the above.

For example, the acquisition unit 11 acquires one or a plurality of attributes as the attribute used for the stratification. The acquisition unit 11 may acquire attributes that are candidates for the attribute used for the stratification. In a case where the data set includes pieces of health-related data, the attribute is, for example, information of one or more items of gender, domicile, nationality, occupation, anamnesis, and family anamnesis. The attribute is not limited to the above. In a case where the data set is a data set classified by an attribute other than the age group, the acquisition unit 11 may acquire information indicating age as the attribute. The acquisition unit 11 acquires, for example, information indicating the attribute used for the stratification from the terminal device 20.

The acquisition unit 11 acquires data and an attribute related to a person or an object that is a target of estimation of a time-series change. In a case where the data set includes pieces of health-related data, the acquisition unit 11 acquires, for example, pieces of health-related data of a target person. The acquisition unit 11 acquires, for example, the latest health-related data among pieces of the health-related data of the target person. For example, in a case where the health-related data is the medical examination result, the acquisition unit 11 acquires a result of a medical examination received by the target person most recently. The acquisition unit 11 acquires, for example, the age of the target person. The age of the target person may be, for example, the age at the time when the health-related data of the target person is measured. The acquisition unit 11 acquires, for example, the data and attribute related to the person or the object that is the target of estimation from the data management device 30. The acquisition unit 11 may acquire the data related to the person or the object that is the target of estimation from the terminal device 20.

The stratification unit 12 stratifies each of data sets based on the attribute acquired by the acquisition unit 11. For example, the stratification unit 12 extracts data matching the attribute acquired by the acquisition unit 11 in each of the data sets. Then, the stratification unit 12 generates, for example, a data set including the extracted data as a stratified data set. The stratified data set is also referred to as, for example, a sub-data set. The match may include a similarity.

The stratification unit 12 may stratify data sets using an attribute related to a feature of a cluster in a case where at least one of the data sets is clustered. For example, in a case where there are candidates S₁, . . . , and Sⱼ for the attribute to be used for the stratification and a cluster classifier is trained using some of these candidates, a set of pieces of attribute information used as an input of the cluster classifier having the highest accuracy rate is set as attributes to be used for the stratification.

The estimation unit 13 estimates a state transition probability between the data sets after the stratification based on a difference in distribution between a state transition probability between the data sets before the stratification and a state transition probability between the data sets stratified for each of the attributes. The estimation unit 13 estimates the state transition probability between the data sets after the stratification using the algorithm related to optimal transport. In the processing of estimating optimal transport between the data sets, for example, the estimation unit 13 estimates the state transition probability between the data sets after the stratification using a first loss regarding a transport cost between the data sets stratified for each of the attributes and a second loss based on the difference in distribution between the state transition probability between the data sets before the stratification and the state transition probability between the stratified data sets. The first loss is calculated, for example, based on the sum of transport costs in the stratified data sets.

The loss functions of the first loss and the second loss are weighted using, for example, a weighting function based on attributes. For example, weights are set in such a way that a larger weight is applied to an attribute that is less likely to change. For example, when the attribute is gender in a case where the data set includes pieces of health-related data, a change in biological gender does not occur, and thus a larger weight is set as compared with an attribute that is likely to change. For example, when the attribute is a lifestyle such as the presence or absence of smoking, a change is likely to occur, and thus a smaller weight is set as compared with the attribute that does not change. The weights may be set in stages based on the likelihood of change. The weights may be determined in such a way that the accuracy of estimation of a transition destination between data sets is improved using actual data in which a transition destination between data sets has been grasped as ground truth data.

For example, the estimation unit 13 estimates a state transition probability from data on a probability distribution of a previous data set on a time series to data on a probability distribution of a subsequent data set on the time series. For example, it is assumed that each of two data sets is a data set including pieces of health-related data, and the two data sets are constituted by a data set including pieces of health-related data in a first age group and a data set including pieces of health-related data in a second age group that is an age group older than the first age group. In this case, the estimation unit 13 estimates, for example, a state transition probability between a data set related to health of a person in the first age group stratified based on the attribute and a data set related to health of the person in the second age group stratified based on the attribute.

The processing of estimating a state transition probability between data sets after the stratification using the algorithm related to optimal transport will be described more specifically. It is assumed that two data sets for which a state transition probability is to be estimated have a distribution μ and a distribution ν. In this case, it is assumed that distributions in data sets stratified to include only data of attributes S among pieces of data included in the two data sets are represented by distributions μ(⋅|S) and ν(⋅|S), respectively. At this time, the estimation unit 13 estimates, for example, optimal transport between μ(⋅|S) and ν(⋅|S) expressed by the following Formula 1.

$$π ( \cdot \vert S ) ∈ Π ( μ ( \cdot \vert S ) , v ( \cdot \vert S ) ) \qquad [ Formula 1 ]$$

For example, the estimation unit 13 estimates the optimal transport, expressed by Formula 1, between μ(⋅|S) and ν(⋅|S) by performing the following processing.

The estimation unit 13 estimates optimal transport expressed by the following Formula 2 that is optimal transport between data sets not related to the attributes.

$$π ∈ Π ( μ , v ) \qquad [ Formula 2 ]$$

The estimation unit 13 defines a first loss as a first loss L₁ for a freely set weighting function w₁(S) as in the following Formula 3.

$${L}_{1} = {E}_{S} [ {w}_{1} ( S ) {\int }_{x \times y} c ( x , y ) π ( dxdy \vert S ) ] \qquad [ Formula 3 ]$$

The above Formula 3 expressing the first loss is a formula expressing optimal transport between the stratified data sets. The estimation unit 13 defines a second loss as a second loss L₂ for a freely set weighting function w₂(S) as in the following Formula 4.

$${L}_{2} = {E}_{S} [ {w}_{2} ( S ) {D}_{KL} ( π \cdot \vert S ) ‖ π ) ] \qquad [ Formula 4 ]$$

In the above Formula 4, D_{KL}(π(⋅|S)∥π) is Kullback-Leibler (KL) divergence. An index used for the second loss is not limited to the KL divergence as long as the index indicates a difference between probability distributions. In the above Formula 4, the second loss indicates, for example, a loss based on a difference between a probability distribution of the unstratified data sets and a probability distribution of the stratified data sets. The second loss is used, for example, to prevent the state transition probability between the stratified data sets from deviating from the overall tendency.

The estimation unit 13 optimizes π(⋅|S) for all the attributes S simultaneously by performing multi-task optimization with respect to the first loss and the second loss. That is, for example, the estimation unit 13 estimates the optimal transport between (S) and ν(⋅|S) by estimating π(⋅|S) in which the first loss and the second loss are simultaneously minimized for all the attributes S. Such multi-task optimization corresponds to, for example, regularization of the second loss based on the first loss.

In the above processing, the estimation unit 13 solves an optimal transport problem using the data sets before the stratification to estimate the overall tendency of the state transition probability, and estimates the state transition probability between the data sets stratified based on attribute information so as not to deviate from the overall tendency. With such estimation, it is possible to suppress over-learning in solving the optimal transport problem even when the quantity of data included in the data set stratified for each of the attributes is small.

In a case where the attributes S are S₁, . . . , and Sⱼ and the number of the attributes Sⱼ in the data set is denoted by kⱼ, the estimation unit 13 may calculate optimal transport π not related to the attributes using the following Formula 5.

$$π = {\sum }_{j = 1}^{J} \frac{{k}_{j}}{{\sum }_{j = 1}^{J} {k}_{j}} π ( \cdot \vert {S}_{j} ) \qquad [ Formula 5 ]$$

When the optimal transport π not related to the attributes is calculated as described above, it is possible to suppress the processing amount in the estimation of the state transition probability between data sets.

The estimation unit 13 estimates a transition destination on the probability distribution of one data set for data within a range in the probability distribution of the other data set based on the state transition probability between the stratified data sets. For example, the estimation unit 13 estimates a transition destination on the probability distribution of the subsequent data set for data within a range in the probability distribution of the previous data set based on the state transition probability between the stratified data sets.

For example, the estimation unit 13 estimates a transition destination in a case where data on the probability distribution based on the previous data set on the time series transitions to the probability distribution based on the subsequent data set on the time series based on the state transition probability between the stratified data sets. For example, in a case where the data set includes pieces of health-related data, the estimation unit 13 estimates health-related data in a case where the age of a person in the first age group becomes the second age group based on, for example, health-related data of the person in the first age group, an attribute of the person, and a state transition probability according to the attribute. For example, in a case where the attribute is male, the estimation unit 13 estimates health-related data in a case where the age of male in the first age group becomes the second age group using the state transition probability estimated based on data sets of pieces of health-related data of male.

The estimation unit 13 may estimate a state transition probability between data sets based on a probability of onset of a disease. For example, the estimation unit 13 estimates a state transition probability between data sets based on a probability of onset of the disease for each of the attributes using a data set including pieces of data of a probability of onset for each age group estimated by the onset probability estimation unit 14. Then, the estimation unit 13 estimates a probability of onset of the disease in a case where the age of a person in the first age group becomes the second age group based on, for example, a probability of onset of the disease of the person in the first age group, an attribute of the person, and a state transition probability according to the attribute.

In a case where the data set includes pieces of health-related data, the onset probability estimation unit 14 estimates a probability of onset of the disease in each of the data sets of pieces of health-related data, for example, using an estimation model for estimating the probability of onset of the disease from the health-related data. For example, the onset probability estimation unit 14 estimates a probability of onset of the disease from data stratified based on the attribute and related to health using the estimation model. The estimation model is, for example, a machine learning model that estimates the probability of onset of the disease using the health-related data as an input.

The estimation model is generated, for example, based on a difference between the probability of onset of the disease estimated using the stratified health-related data and a probability of onset based on unstratified health-related data. The estimation model is generated by machine learning using, for example, a third loss based on the probability of onset of the disease estimated using the stratified health-related data and ground truth data, and a fourth loss based on a difference between the probability of onset of the disease estimated using the stratified health-related data and the probability of onset based on the unstratified health-related data. A loss function of each of the third loss and the fourth loss includes, for example, a weighting function based on attributes. For example, weights are set in such a way that a larger weight is applied as the influence on the disease increases. For example, in estimation of a probability of onset of diabetes, a weight larger than other weights is set for an attribute regarding the presence or absence of drinking.

The estimation model is generated as follows, for example. A learning device that generates the estimation model generates an estimation model f(x) that does not depend on the attribute. For example, the learning device generates the estimation model f(x) by performing machine learning using learning data not stratified based on the attribute.

The learning device defines a first loss as the third loss for a freely set weighting function w₁(S) as in the following Formula 6.

$${L}_{1} = {E}_{S} [ {w}_{1} ( S ) {ℓ}_{1} ( f ( X \vert S ) , Y ) ] \qquad [ Formula 6 ]$$

The above Formula (6) expressing the third loss is a formula expressing a loss based on a difference between an estimation result based on a stratified data set and ground truth data. The learning device defines a second loss as the fourth loss for a freely set weighting function w₂(S) as in the following Formula 7.

$${L}_{2} = {E}_{S} [ {w}_{2} ( S ) {ℓ}_{2} ( f ( X \vert S ) , f ( X ) ) ] \qquad [ Formula 7 ]$$

The above Formula 7 expressing the fourth loss expresses, for example, a loss based on a difference between an estimation result of the estimation model based on an unstratified data set and the estimation result of the estimation model based on the stratified data set. The fourth loss expressed by Formula 7 is used, for example, to prevent the estimation result based on the stratified data set from deviating from the overall tendency.

For example, the learning device optimizes f(x|S) for all the attributes S simultaneously by performing multi-task optimization with respect to the third loss and the fourth loss. For example, the learning device generates the estimation model by estimating f(x|S) in which the third loss and the fourth loss are simultaneously minimized for all the attributes S. Such multi-task optimization corresponds to, for example, regularization of the fourth loss based on the third loss.

In the above processing, the learning device generates the estimation model in such a way that the estimation result obtained by the estimation model using the stratified data set does not deviate from the overall tendency. Since the estimation model is generated in this manner, it is possible to suppress over-learning in the generation of the estimation model even when the quantity of data included in the data set stratified for each of the attributes is small.

The output unit 15 outputs, for example, a state transition probability between data sets after stratification. For example, the output unit 15 stores the state transition probability between the data sets after the stratification as data for each of attributes. The output unit 15 may output a map of the state transition probability between the data sets after the stratification as the data for each of the attributes. The output unit 15 may output the state transition probability for each of the attributes and a state transition probability between unstratified data sets. The output unit 15 outputs, for example, the map of the state transition probability for each of the attributes and a map of the state transition probability between the unstratified data sets. The output unit 15 outputs the state transition probability between the data sets after the stratification for each of the attributes, for example, to the storage unit 16 to store the state transition probability between the data sets after the stratification for each of the attributes. The output unit 15 outputs the state transition probability between the data sets after the stratification for each of the attributes, for example, to the terminal device 20. The output unit 15 may output the state transition probability between the data sets after the stratification for each of the attributes, for example, to the data management device 30.

The output unit 15 outputs, for example, an estimation result of a transition destination of data. In a case where a data set includes pieces of health-related data, the output unit 15 outputs, for example, an estimation result of data related to future health of a target person. The output unit 15 outputs health-related data in a case where the age of the target person has increased based on the estimation result of the transition destination. The output unit 15 outputs, for example, health-related data of the target person in a first age group and health-related data in a case where the age of the target person has increased to a second age group. For example, in a case where the first age group is 50 years old and the second age group is 70 years old, the output unit 15 outputs health-related data of the target person at 50 years old and an estimation result of the health-related data at 70 years old. The output unit 15 may output an estimation result of a probability of onset of a disease in the future of the target person. The output unit 15 outputs the estimation result of the transition destination of data, for example, to the terminal device 20.

The storage unit 16 stores, for example, information regarding the processing of estimating a state transition probability between data sets. The storage unit 16 stores, for example, the data sets used for the processing of estimating the state transition probability. The storage unit 16 stores, for example, the state transition probability for each of attributes. In a case where the data set includes pieces of health-related data, the storage unit 16 stores, for example, a state transition probability between pieces of health-related data for each of the attributes. The storage unit 16 stores, for example, the estimation model. The estimation model may be stored in a storage means outside the data estimation device 10.

The terminal device 20 is, for example, a terminal device that accesses the data estimation device 10 and is used for the processing of estimating the state transition probability between the data sets. The terminal device 20 acquires, for example, an estimation result of a state transition probability between data sets from the output unit 15 of the data estimation device 10. In a case where the data set includes pieces of health-related data, the terminal device 20 acquires, for example, a state transition probability between pieces of health-related data of different age groups. The terminal device 20 outputs the estimation result of the state transition probability between the data sets to, for example, a display device (not illustrated).

The terminal device 20 acquires, for example, an estimation result of a transition destination of data from the output unit 15 of the data estimation device 10. In a case where the data set includes pieces of health-related data, the terminal device 20 acquires, for example, an estimation result of health-related data in a case where the age of a target person has increased. The terminal device 20 outputs the estimation result of the transition destination of the data to, for example, a display device (not illustrated).

The terminal device 20 acquires, for example, an attribute of data that is a target of estimation of a transition destination, the data being input by an operation of an operator. Then, the terminal device 20 outputs the attribute of the data that is the target of estimation of the transition destination to the acquisition unit 11 of the data estimation device 10, for example. In addition, when the data that is the target of estimation of the transition destination is input to the terminal device 20, the terminal device 20 outputs the data that is the target of estimation of the transition destination to, for example, the acquisition unit 11 of the data estimation device 10.

In a case where a data set includes pieces of health-related data, the operator using the terminal device 20 is, for example, a target person or a person who gives advice for making a decision on health or assets to the target person. The person who gives advice to the target person is, for example, a medical worker, an insurance person, a human resource person, a financial planner, or a person in charge of a financial institution. The medical worker is a physician, nurse, physical therapist, pharmacist, laboratory technician, or even a consultant. The medical worker is not limited to the above. The person who gives advice to the target person is not limited to the above.

As the terminal device 20, for example, a personal computer, a tablet computer, a smartphone, or a smartwatch can be used. An information processing device used for the terminal device 20 is not limited to the above.

The data management device 30 stores, for example, data sets to be used for estimating a state transition probability. For example, the data management device 30 stores a data set and attributes of pieces of data included in the data set in association with each other. The data management device 30 stores, for example, health-related data as the data sets to be used for estimating the state transition probability. For example, the data management device 30 may store health-related data in association with a measurement date of the health-related data and the age of a person relevant to the health-related data. The data management device 30 outputs the data sets and the attributes to the acquisition unit 11 of the data estimation device 10, for example.

In a case where the data set includes pieces of health-related data, pieces of the health-related data are, for example, medical examination results for each age group. The data management device 30 stores, for example, the execution date of a medical examination, an attribute of a person who has received the medical examination, and a result of the medical examination in association with each other. The attribute is, for example, information of one or more items of age, gender, domicile, nationality, occupation, previous disease, and previous disease of a family. The attribute is not limited to the above. The execution date of the medical examination may be information indicated by the month, year, or year in which the medical examination was conducted. The data management device 30 may store the result of the medical examination as a database classified based on at least one of the execution date of the medical examination and the attribute of the person who has received the medical examination.

In a case where the data set is the medical examination result, the data management device 30 may store, for example, the medical examination result as anonymized information or pseudonymized information. The anonymized information is, for example, information processed in such a way that an individual cannot be identified even if the anonymized information is collated with other information. The pseudonymized information is, for example, information processed in such a way that an individual cannot be identified by itself but can be identified when collated with other information.

The data management device 30 may store a result of a medical examination conducted for a predetermined group. The predetermined group is, for example, a group having the medical examination. The predetermined group is, for example, a municipality, a company, an association, a cooperative association, a school, or a health insurance association. The predetermined group is not limited to the above. The data management device 30 may store results of the medical examination of a plurality of groups.

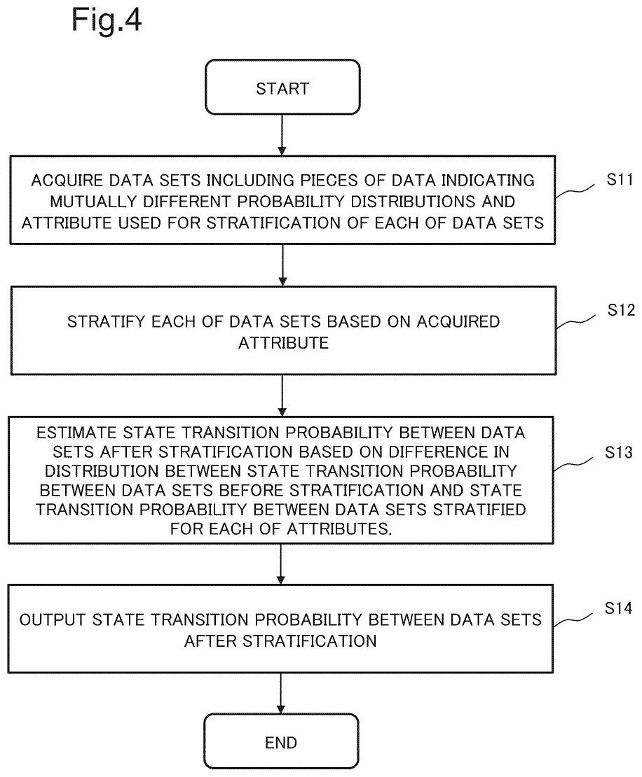

Processing in which the data estimation device 10 estimates a state transition probability between data sets after stratification will be described. FIG. 4 illustrates an example of an operation flow regarding the processing in which the data estimation device 10 estimates the state transition probability between the data sets after the stratification.

The acquisition unit 11 acquires data sets including pieces of data indicating mutually different probability distributions and an attribute used for stratification of the data sets (step S11). The acquisition unit 11 acquires the data sets from the data management device 30, for example. The acquisition unit 11 acquires, for example, the attribute used for the stratification of each of the data sets from the terminal device 20.

When the data set and the attribute used for the stratification of each of the data sets are acquired, the stratification unit 12 stratifies each of the data sets based on the acquired attribute (step S12).

When the data sets are stratified, the estimation unit 13 estimates a state transition probability between the data sets after the stratification based on a difference in distribution between a state transition probability between the data sets before the stratification and a state transition probability between the data sets stratified for each of the attributes (step S13).

When the state transition probability between the data sets after the stratification is estimated, the output unit 15 outputs the state transition probability between the data sets after the stratification (step S14). The output unit 15 outputs the state transition probability between the data sets after the stratification, for example, to the storage unit 16 to store the state transition probability between the data sets after the stratification. The output unit 15 may output the state transition probability between the data sets after the stratification, for example, to the terminal device 20.

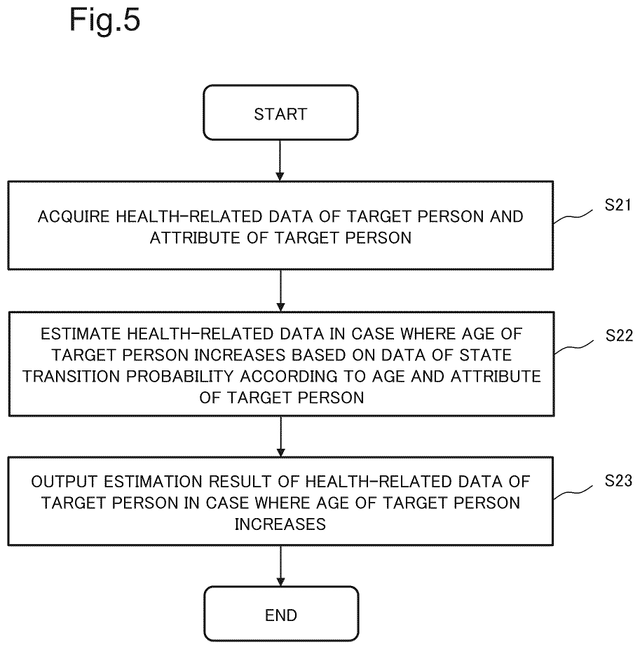

An operation in which the data estimation device 10 estimates health-related data in a case where the age of a target person has increased based on a state transition probability when a data set is health-related data for each age group will be described. FIG. 5 is an example of an operation flow of processing in which the data estimation device 10 estimates health-related data in a case where the age of a target person has increased.

The acquisition unit 11 acquires, for example, health-related data of the target person and an attribute of the target person (step S21). The acquisition unit 11 acquires the health-related data of the target person from the data management device 30, for example. The acquisition unit 11 acquires the age and the attribute of the target person from the terminal device 20, for example.

When the health-related data of the target person and the attribute of the target person are acquired, the estimation unit 13 estimates the health-related data in a case where the age of the target person has increased based on data of a state transition probability according to the age and the attribute of the target person (step S22). Based on the data of the state transition probability according to the age and the attribute of the target person, the estimation unit 13 estimates data of a transition destination of the health-related data of the target person as the health-related data in a case where the age of the target person increases.

When the health-related data of the target person in a case where the age of the target person has increased is estimated, the output unit 15 outputs the health-related data of the target person in a case where the age of the target person has increased (step S23). The output unit 15 outputs the health-related data of the target person in a case where the age of the target person has increased, for example, to the terminal device 20.

Each processing in the data estimation device 10 may be executed in a distributed manner in a plurality of information processing devices connected via a network. For example, the processing in the stratification unit 12 and the processing in the estimation unit 13 may be performed in different information processing devices. Which information processing device performs each processing in the data estimation device 10 can be appropriately set.

The data estimation device 10 stratifies each of the data sets including pieces of data indicating mutually different probability distributions based on the attributes. The data estimation device 10 estimates the state transition probability between the data sets after the stratification based on the difference in distribution between the state transition probability between the data sets before the stratification and the state transition probability between the data sets stratified for each of the attributes. With such estimation, the data estimation device 10 can suppress over-learning in the estimation of the state transition probability between the stratified data sets. Therefore, the data estimation device 10 can improve the estimation accuracy of the state transition probability.

The data estimation device 10 solves the optimal transport problem using, for example, the data sets before the stratification, and estimates the overall tendency of the state transition probability. Then, the data estimation device 10 estimates, for example, the state transition probability between the stratified data sets so as not to deviate from the overall tendency. With such estimation, the data estimation device 10 can suppress over-learning in solving the optimal transport problem even when the quantity of data included in the data set stratified for each of the attributes is small.

For example, the data estimation device 10 performs weighting on the loss function used to solve the optimal transport problem in such a way that a larger weight is applied to an attribute that is less likely to change. Since the larger weight is applied to the attribute that is less likely to change, it is possible to suppress the influence of an attribute that is likely to vary an estimation result. Therefore, since the influence of data having the attribute that is likely to vary the estimation result is suppressed, it is possible to suppress a state that greatly affects the entire estimation result even though the quantity of data is small, and thus, it is possible to suppress the over-learning in solving the optimal transport problem.

When a transition destination of data is estimated based on the state transition probability estimated as described above, the data estimation device 10 can estimate a future state without requiring long-term data for the same person or object, for example. Therefore, for example, the data estimation device 10 can support decision making of a person who uses the estimation result of the transition destination of the data.

In a case where the data set includes pieces of health-related data, the data estimation device 10 can estimate health-related data in a case where the age of a target person has increased, for example, by estimating a transition destination of the health-related data of the target person based on the state transition probability. The data estimation device 10 can estimate data related to future health without requiring long-term health-related data of the same person, for example. Therefore, the data estimation device 10 can easily estimate health-related data in a case where the age has increased. By estimating health-related data in a case where the age has increased, the data estimation device 10 can support, for example, decision-making regarding health performed by the target person.

By estimating a disease onset probability, the data estimation device 10 can provide information regarding the future disease onset risk of the target person. By estimating a medical cost necessary for taking medical care in the future, the data estimation device 10 can provide information for creating a plan for the asset of the target person.

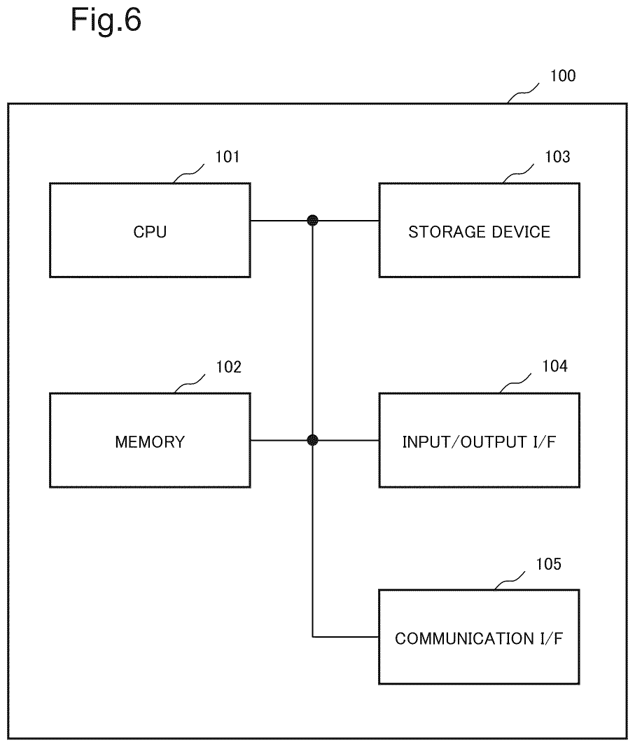

Each processing in the data estimation device 10 can be implemented by executing a computer program on a computer. FIG. 6 illustrates an example of a configuration of a computer 100 that executes a computer program for executing each processing in the data estimation device 10. The computer 100 includes a central processing unit (CPU) 101, a memory 102, a storage device 103, an input/output interface (I/F) 104, and a communication I/F 105.

The CPU 101 reads and executes a computer program for executing each processing from the storage device 103. The CPU 101 may be configured by a combination of a plurality of CPUs. The CPU 101 may be configured by a combination of a CPU and another type of processor. For example, the CPU 101 may be configured by a combination of a CPU and a graphics processing unit (GPU). The memory 102 includes a dynamic random access memory (DRAM) or the like, and temporarily stores a computer program executed by the CPU 101 and data being processed. The storage device 103 stores the computer program executed by the CPU 101. The storage device 103 includes, for example, a non-volatile semiconductor storage device. The storage device 103 may include another storage device such as a hard disk drive. The input/output I/F 104 is an interface that receives an input from an operator to output display data and the like. The communication I/F 105 is an interface that transmits and receives data to and from the terminal device 20, the data management device 30, and other information processing devices. The terminal device 20 and the data management device 30 can also be configured as in the computer 100.

The computer program used for executing each processing can also be distributed by being stored in a computer-readable recording medium that non-transiently records data. The recording medium can include, for example, a magnetic tape for data recording or a magnetic disk such as a hard disk. The recording medium may include an optical disk such as a compact disc read only memory (CD-ROM). Anon-volatile semiconductor storage device may be used as the recording medium.

In data analysis or the like, a transition of data may be estimated based on a state transition probability between a plurality of data sets having mutually different distributions. In a case where the data sets are used for analysis, data sets stratified according to an attribute may be used in order to perform analysis according to an analysis target. For example, in a case where the attribute is gender, a state transition probability between pieces of data of the gender is estimated using pieces of data stratified based on the gender. Then, a transition destination of data, which is the analysis target, is estimated based on the estimated state transition probability.

A prediction model construction device of JP 2016-95684 A clusters pieces of medical data in the form of a word frequency for each age to generate a cluster for each age. Then, the prediction model construction device of JP 2016-95684 A estimates a transition probability in an aging direction between clusters in adjacent ages based on a similarity between the clusters. However, in the technique described in JP 2016-95684 A, in a case where there is a small amount of data for each of the attributes, over-learning may occur in estimation of the state transition probability between the data sets stratified based on the attribute.

In order to solve the over problem, an object of the present disclosure is to provide a data estimation device and the like capable of suppressing over-learning in estimation of a state transition probability between stratified data sets.

According to the present disclosure, it is possible to suppress the over-learning in the estimation of the state transition probability between the stratified data sets.

Some or all of the above example embodiments may be described as the following Supplementary Notes, but are not limited to the following.

### Supplementary Note 1

A data estimation device including:
an acquisition unit that acquires data sets including pieces of data indicating mutually different probability distributions and an attribute used for stratification of each of the data sets;
a stratification unit that stratifies each of the data sets based on the acquired attribute;
an estimation unit that estimates a state transition probability between data sets after the stratification based on a difference in distribution between a state transition probability between the data sets before the stratification and a state transition probability between data sets stratified for each of the attributes; and
an output unit that outputs the state transition probability between the data sets after the stratification.

### Supplementary Note 2

The data estimation device according to Supplementary Note 1, wherein
the estimation unit estimates the state transition probability between the data sets after the stratification using a first loss regarding a transport cost between the data sets stratified for each of the attributes and a second loss based on the difference in distribution between the state transition probability between the data sets before the stratification and the state transition probability between the stratified data sets.

### Supplementary Note 3

The data estimation device according to Supplementary Note 2, wherein
a loss function of each of the first loss and the second loss includes a weighting function based on the attribute.

### Supplementary Note 4

The data estimation device according to any one of Supplementary Notes 1 to 3, further including an onset probability estimation unit that estimates a probability of onset of a disease in each of data sets of pieces of health-related data using an estimation model for estimating the probability of onset of the disease from pieces of the health-related data,
wherein the estimation unit estimates a state transition probability between the data sets based on the probability of onset of the disease.

### Supplementary Note 5

The data estimation device according to Supplementary Note 4, wherein
the estimation model is generated by machine learning using a third loss based on a probability of onset of a disease estimated using stratified health-related data and ground truth data, and a fourth loss based on a difference between a probability of onset of the disease estimated using the stratified health-related data and a probability of onset based on unstratified health-related data.

### Supplementary Note 6

The data estimation device according to Supplementary Note 5, wherein
a loss function of each of the third loss and the fourth loss includes a weighting function based on the attribute.

### Supplementary Note 7

The data estimation device according to any one of Supplementary Notes 1 to 6, wherein
the stratification unit stratifies each of the data sets using the attribute related to a feature of a cluster in a case where at least one of the data sets has been clustered.

### Supplementary Note 8

The data estimation device according to any one of Supplementary Notes 1 to 7, wherein
the data sets are data sets including pieces of data having mutually different positions in a time-series direction, and
the estimation unit estimates a state transition probability from data on a probability distribution of a previous data set on a time series to data on a probability distribution of a subsequent data set on the time series.

### Supplementary Note 9

The data estimation device according to Supplementary Note 8, wherein
the estimation unit estimates a transition destination in a case where the data on the probability distribution based on the previous data set on the time series transitions to the probability distribution based on the subsequent data set on the time series based on the state transition probability.

### Supplementary Note 10

The data estimation device according to any one of Supplementary Notes 1 to 3, wherein
the data sets are data sets including pieces of health-related data in a first age group and pieces of health-related data in a second age group, which is an age group older than the first age group, respectively, and
the estimation unit estimates a state transition probability between health-related data of a person in the first age group stratified based on the attribute and health-related data of the person in the second age group stratified based on the attribute.

### Supplementary Note 11

The data estimation device according to Supplementary Note 10, wherein
the estimation unit estimates health-related data in a case where an age of the person in the first age group becomes the second age group based on the health-related data of the person in the first age group and the state transition probability.

### Supplementary Note 12

The data estimation device according to Supplementary Note 2, wherein
the first loss is calculated based on a sum of transport costs in each of the stratified data sets.

### Supplementary Note 13

A data estimation method including:
acquiring data sets including pieces of data indicating mutually different probability distributions and an attribute used for stratification of each of the data sets;
stratifying each of the data sets based on the acquired attribute;
estimating a state transition probability between data sets after the stratification based on a difference in distribution between a state transition probability between the data sets before the stratification and a state transition probability between data sets stratified for each of the attributes; and
outputting the state transition probability between the data sets after the stratification.

### Supplementary Note 14

A data estimation program for causing a computer to execute processing including:
acquiring data sets including pieces of data indicating mutually different probability distributions and an attribute used for stratification of each of the data sets;
stratifying each of the data sets based on the acquired attribute;
estimating a state transition probability between data sets after the stratification based on a difference in distribution between a state transition probability between the data sets before the stratification and a state transition probability between data sets stratified for each of the attributes; and
outputting the state transition probability between the data sets after the stratification.

Some or all of the configurations described in Supplementary Notes 2 to 12 dependent on the above-described Supplementary Note 1 can also be dependent on Supplementary Notes 13 and 14 by the same dependency relationship as in Supplementary Notes 2 to 12. Furthermore, some or all of the configurations described as the Supplementary Notes can be similarly dependent on not only the Supplementary Notes 1, 13, and 14, but also various pieces of hardware and software, and various recording means or systems for recording software without departing from the above-described example embodiments.

The previous description of embodiments is provided to enable a person skilled in the art to make and use the present disclosure. Moreover, various modifications to these example embodiments will be readily apparent to those skilled in the art, and the generic principles and specific examples defined herein may be applied to other embodiments without the use of inventive faculty. Therefore, the present disclosure is not intended to be limited to the example embodiments described herein but is to be accorded the widest scope as defined by the limitations of the claims and equivalents.

Further, it is noted that the inventor's intent is to retain all equivalents of the claimed invention even if the claims are amended during prosecution.

1. A data estimation device comprising:
at least one memory storing instructions; and
at least one processor configured to access the at least one memory and execute the instructions to:
acquire data sets including pieces of data indicating mutually different probability distributions and an attribute used for stratification of each of the data sets;
stratify each of the data sets based on the acquired attribute;
estimate a state transition probability between data sets after the stratification based on a difference in distribution between a state transition probability between the data sets before the stratification and a state transition probability between data sets stratified for each of the attributes; and
output the state transition probability between the data sets after the stratification.

2. The data estimation device according to claim 1, wherein
the at least one processor is further configured to execute the instructions to:
estimate the state transition probability between the data sets after the stratification using a first loss regarding a transport cost between the data sets stratified for each of the attributes and a second loss based on the difference in distribution between the state transition probability between the data sets before the stratification and the state transition probability between the stratified data sets.

3. The data estimation device according to claim 2, wherein
a loss function of each of the first loss and the second loss includes a weighting function based on the attribute.

4. The data estimation device according to claim 1, wherein
the at least one processor is further configured to execute the instructions to:
estimate a probability of onset of a disease in each of data sets of pieces of health-related data using an estimation model for estimating the probability of onset of the disease from pieces of the health-related data; and
estimate a state transition probability between the data sets based on the probability of onset of the disease.

5. The data estimation device according to claim 4, wherein
the estimation model is generated by machine learning using a third loss based on a probability of onset of a disease estimated using stratified health-related data and ground truth data, and a fourth loss based on a difference between a probability of onset of the disease estimated using the stratified health-related data and a probability of onset based on unstratified health-related data.

6. The data estimation device according to claim 5, wherein
a loss function of each of the third loss and the fourth loss includes a weighting function based on the attribute.

7. The data estimation device according to claim 1, wherein
the at least one processor is further configured to execute the instructions to:
stratify each of the data sets using the attribute related to a feature of a cluster in a case where at least one of the data sets has been clustered.

8. The data estimation device according to claim 1, wherein
the data sets are data sets including pieces of data having mutually different positions in a time-series direction, and
the at least one processor is further configured to execute the instructions to:
estimate a state transition probability from data on a probability distribution of a previous data set on a time series to data on a probability distribution of a subsequent data set on the time series.

9. The data estimation device according to claim 8, wherein
the at least one processor is further configured to execute the instructions to:
estimate a transition destination in a case where the data on the probability distribution based on the previous data set on the time series transitions to the probability distribution based on the subsequent data set on the time series based on the state transition probability.

10. The data estimation device according to claim 1, wherein
the data sets are data sets including pieces of health-related data in a first age group and pieces of health-related data in a second age group, which is an age group older than the first age group, respectively, and
the at least one processor is further configured to execute the instructions to:
estimate a state transition probability between health-related data of a person in the first age group stratified based on the attribute and health-related data of the person in the second age group stratified based on the attribute.

11. The data estimation device according to claim 10, wherein
the at least one processor is further configured to execute the instructions to:
estimate health-related data in a case where an age of the person in the first age group becomes the second age group based on the health-related data of the person in the first age group and the state transition probability.

12. The data estimation device according to claim 2, wherein
the first loss is calculated based on a sum of transport costs in each of the stratified data sets.

13. A data estimation method comprising:
acquiring data sets including pieces of data indicating mutually different probability distributions and an attribute used for stratification of each of the data sets;
stratifying each of the data sets based on the acquired attribute;
estimating a state transition probability between data sets after the stratification based on a difference in distribution between a state transition probability between the data sets before the stratification and a state transition probability between data sets stratified for each of the attributes; and
outputting the state transition probability between the data sets after the stratification.

14. A non-transitory recording medium recording a data estimation program for causing a computer to execute processing including:
acquiring data sets including pieces of data indicating mutually different probability distributions and an attribute used for stratification of each of the data sets;
stratifying each of the data sets based on the acquired attribute;
estimating a state transition probability between data sets after the stratification based on a difference in distribution between a state transition probability between the data sets before the stratification and a state transition probability between data sets stratified for each of the attributes; and
outputting the state transition probability between the data sets after the stratification.
